(19) United States
(12) Patent Application Publication
(10) Pub. No.: US 2012/0032951 A1
(43) Pub. Date: Feb. 9, 2012

(54) APPARATUS AND METHOD FOR RENDERING OBJECT IN 3D GRAPHIC TERMINAL

(75) Inventors: Sang-Kyung Lee, Anyang-si (KR); Kwang-Cheol Choi, Gwacheon-si (KR); Hyung-Jin Bae, Pyeongtaek-si (KR)

(73) Assignee: SAMSUNG ELECTRONICS CO., LTD., Suwon-si (KR)

(21) Appl. No.: 13/197,545

(22) Filed: Aug. 3, 2011

(30) Foreign Application Priority Data
Aug. 3, 2010 (KR) 10-2010-0074844

(51) Int. Cl. G06T 15/00

(52) U.S. Cl. 345/419

(57) ABSTRACT

A method for rendering an object in a 3D graphic terminal includes constructing camera coordinates, based on vertex information of objects existing in a 3D space, and selecting one object in a left frustum and a right frustum, based on the constructed camera coordinates, wherein the left frustum is defined centered on a left virtual camera viewpoint, and the right frustum is defined centered on a right virtual camera viewpoint. The method further includes determining a binocular disparity by projecting vertexes of the selected object in the left frustum and the right frustum, and adjusting frustum parameters of the left virtual camera and the right virtual camera when the determined binocular disparity is greater than an allowable binocular disparity.

### CROSS-REFERENCE TO RELATED APPLICATION(S) AND CLAIM OF PRIORITY

The present application is related to and claims priority under 35 U.S.C. §119 to an application filed in the Korean Intellectual Property Office on Aug. 3, 2010 and assigned Serial No. 10-2010-0074844, the contents of which are incorporated herein by reference.

### TECHNICAL FIELD OF THE INVENTION

The present invention relates generally to an apparatus and method for rendering an object in a three-dimensional (3D) graphic terminal, and more particularly, to an apparatus and method for rendering an object, which may reduce the occurrence of diplopia in a 3D graphic terminal. The 3D graphic terminal used herein generally refers to a terminal that can convert an image rendered by a 3D graphic technique into a stereoscopic multiview image based on a binocular disparity in a terminal that can output a stereoscopic multiview image.

### BACKGROUND OF THE INVENTION

As virtual reality systems, computer games, and so on, have been developed, research and development has been conducted to express a real-world object and terrain three-dimensionally by using computer systems

In general, a user can feel a 3D effect while watching a target object in different directions with his or her left and right eyes. Therefore, if a two-dimensional (2D) flat panel display device simultaneously displays two image frames to which a binocular disparity, i.e., a difference of left and right eyes, is reflected, a user can view a relevant image three-dimensionally.

Conventionally, techniques have been implemented that use a virtual camera to acquire two image frames that provide binocular disparity. That is, by using a virtual camera in vertex processing of a general 3D graphic pipeline, a binocular disparity is generated in a virtual space through a frustum parameter setting of the virtual camera. The virtual space is then rendered in an existing pipeline to acquire two image frames to provide the binocular disparity.

In such techniques, however, it is often difficult to apply an appropriate binocular disparity to 3D contents having various virtual space sizes in practice. Because the frustum parameters of the virtual camera are fixed in the development process. Such a problem often results in the output of two image frames to which a binocular disparity greater than an allowable binocular disparity is applied. Consequently, diplopia occurs and a user may suffer from eyestrain. In serious cases, a user may potentially lose his or her eyesight or suffer from a headache.

### SUMMARY OF THE INVENTION

To address the above-discussed deficiencies of the prior art, it is a primary object to provide at least the advantages below. Accordingly, an object of the present invention is to provide an apparatus and method for rendering an object in a three-dimensional (3D) graphic terminal.

Another object of the present invention is to provide an apparatus and method for rendering an object, in which frustum parameters of a virtual camera are dynamically adjusted by analyzing a binocular disparity in a virtual space with respect to a target object in a vertex processing of a 3D graphic pipeline in a 3D graphic terminal.

Another object of the present invention is to provide an apparatus and method for rendering an object, in which an object whose binocular disparity is greater than an allowable binocular disparity in a virtual space is clipped or is rendered to relieve eyestrain in a vertex processing of a 3D graphic pipeline in a 3D graphic terminal.

According to an aspect of the present invention, a method for rendering an object in a 3D graphic terminal includes constructing camera coordinates based on vertex information of objects existing in a 3D space, and selecting one object in a left frustum and a right frustum, based on the constructed camera coordinates, wherein the left frustum is defined centered on a left virtual camera viewpoint, and the right frustum is defined centered on a right virtual camera viewpoint. The method further includes determining a binocular disparity by projecting vertexes of the selected object in the left frustum and the right frustum, and adjusting frustum parameters of the left virtual camera and the right virtual camera when the determined binocular disparity is greater than an allowable binocular disparity.

According to another aspect of the present invention, a 3D graphic terminal includes a binocular disparity determining unit for constructing camera coordinates, based on vertex information of objects existing in a 3D space, and selecting one object in a left frustum and a right frustum, based on the constructed camera coordinates, wherein the left frustum is defined centered on a left virtual camera viewpoint and the right frustum is defined centered on a right virtual camera viewpoint. The binocular disparity determine unit may also determine a binocular disparity by projecting vertexes of the selected object in the left frustum and the right frustum The 3D graphic terminal also includes a frustum parameter modifying unit for adjusting frustum parameters of the left virtual camera and the right virtual camera when the determined binocular disparity is greater than an allowable binocular disparity.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIGS. 1A to 1D illustrate a vertex processing of a 3D graphic pipeline in a 3D graphic terminal according to an embodiment of the present invention;

FIG. 2 illustrates an example method for dynamically adjusting frustum parameters (especially, a near plane) in a transformation into camera coordinates during a vertex processing of a 3D graphic pipeline in a 3D graphic terminal according to an embodiment of the present invention;

FIG. 3 illustrates an example configuration of a 3D graphic terminal according to an embodiment of the present invention;

FIG. 4 illustrates an example detailed configuration of a vertex processor included in a graphic processing unit in a 3D graphic terminal according to an embodiment of the present invention; and

FIG. 5 illustrates an example method for rendering an object in a 3D graphic terminal according to an embodiment of the present invention.

### DETAILED DESCRIPTION OF THE INVENTION

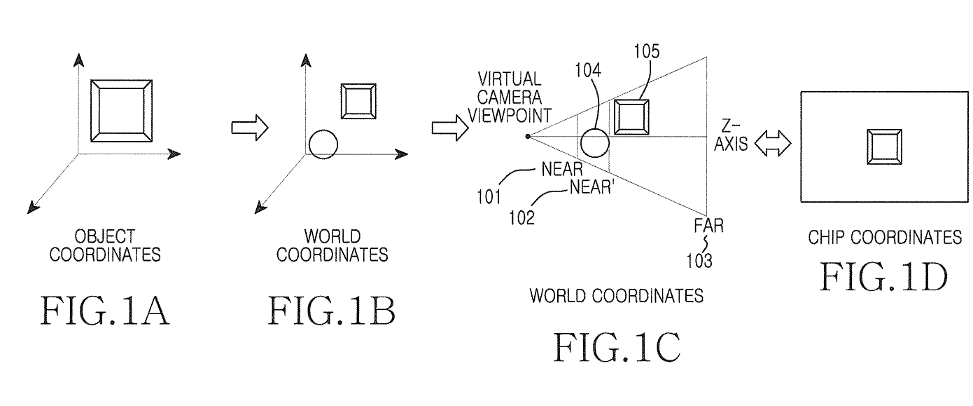

FIGS. 1A through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged graphics terminals In the following description, detailed descriptions of well-known functions or configurations will be omitted since they would unnecessarily obscure the subject matters of the present invention.

Hereinafter, an apparatus and method for rendering an object in order to prevent the occurrence of diplopia in a 3D graphic terminal according to an embodiment of the present invention will be described. The 3D graphic terminal used herein refers to a terminal that can convert an image rendered by a 3D graphic technique into a stereoscopic multiview image based on a binocular disparity in a terminal that can output a stereoscopic multiview image.

Examples of the terminal used herein include a cellular phone, a personal communication system (PCS), a personal data assistant (PDA), International Mobile Telecommunication-2000 (IMT-2000) terminal, a personal computer (PC), a notebook computer, a television, and the like. The following description will be made focusing on the general configuration of these exemplary terminals.

FIGS. 1A to 1D illustrate a vertex processing of a 3D graphic pipeline in a 3D graphic terminal according to an embodiment of the present invention.

As illustrated in FIG. 1A, a terminal defines object coordinates or local coordinates, in which the center of an object is the center of a coordinate axis, based on vertex information (i.e., coordinates information) of each object existing in a space.

Then, as illustrated in FIG. 1B, world coordinates covering the entire space are constructed based on the defined object coordinates. The world coordinates cover the object coordinates of all objects forming the entire space and represent the positions of the respective objects within the 3D space.

Then, as illustrated in FIG. 1C, the terminal transforms the constructed world coordinates into camera coordinates or eye coordinates, which are centered on a virtual camera viewpoint, and determines objects to be rendered among the objects forming the entire space. The virtual camera designates a part of the world coordinates an observer can view. The virtual camera determines which portion of the world coordinates is needed in order to create a 2D image, and defines a frustum, i.e., a volume of a space that is located within the world coordinates and is to be viewed. The frustum generally refers to parameters, such as a view angle, a near plane 101, and a far plane 103. The values of the respective parameters are previously set upon creation of contents. The view angle refers to a view angle of the virtual camera. The near plane 101 and the far plane 103 represent X-Y planes existing at positions previously determined from the virtual camera viewpoint with respect to Z-axis, and determine a space covering objects to be rendered. The Z-axis represents a viewpoint direction of the virtual camera, such as, a view direction of the virtual camera. Objects that are included in the space between the near plane 101 and the far plane 103 are subsequently rendered, while objects that are not included in the space between the near plane 101 and the far plane 103 are subsequently removed by clipping.

In addition, the terminal according to an embodiment of the present invention analyzes a spatial binocular disparity with respect to the objects, which are included in the space between the near plane 101 and the far plane 103, by using left and right virtual cameras, and dynamically adjusts and modifies the near plane 101 according to the analysis result. For example, the terminal may determine a binocular disparity of an object 104, which is closest to the near plane 101 among the objects included in the space between the near plane 101 and the far plane 103, by calculating a difference of coordinates mapped on a screen when a vertex of the object 104 is projected. If the determined binocular disparity is greater than an allowable binocular disparity, the corresponding object 104 is determined as an object from which a user cannot feel a 3D effect. Thus, the near plane 101 may be modified into another near plane 102 to which the allowable binocular disparity is reflected. The object 105 included in the space between the near plane 102 and the far plane 103 may be subsequently rendered. The object 104 included in the space between the near plane 101 and the near plane 102 may be subsequently removed by clipping, or may be rendered in such a manner that a user may feel less eyestrain.

Then, as illustrated in FIG. 1D, the terminal projects the camera coordinates and transforms the camera coordinates into clip coordinates or projection coordinates. That is, the terminal performs a rendering to transform a 3D space into a 2D image. For example, the terminal may perform a clipping to remove the objects that are not included in the space between the near plane 101 and the far plane 103, and may perform a clipping to remove the object 104, which is included between the near plane 101 and the near plane 102, or may perform a rendering the object 104 in such a manner that a user feels less eyestrain. The terminal may render an object 105 that is included in the space between the near plane 102 and the far plane 103.

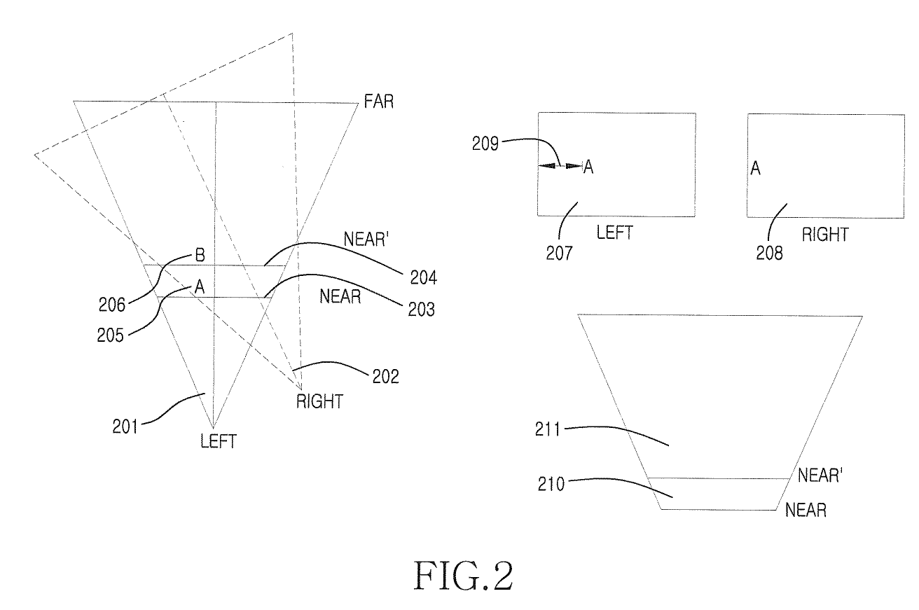

FIG. 2 illustrates an example method for dynamically adjusting frustum parameters (especially, a near plane) in a transformation into camera coordinates during a vertex processing of a 3D graphic pipeline in a 3D graphic terminal according to an embodiment of the present invention.

The terminal determines an object to be rendered among all objects forming an entire space by transforming world coordinates into camera coordinates. To this end, a left frustum 201 centered on a left virtual camera viewpoint and a right frustum 202 centered on a right virtual camera viewpoint may be defined. In the left frustum 201 and the right frustum 202, an object A 205 included in the space between a near plane 203 and a far plane is projected and mapped on a left screen 207 and a right screen 208, and the object A 205 has a binocular disparity 209 between the left frustum 201 and the right frustum 202. If the binocular disparity 209 is greater than an allowable binocular disparity, a user may not feel a 3D effect, but may yet experience diplopia. To reduce this problem, the near plane 203 among the frustum parameters may be changed to a near plane 204 to which the allowable binocular disparity is reflected. That is, the position of the near plane 203 on the Z-axis may be changed such that a binocular disparity of an object to be included in a final binocular image becomes less than or equal to the allowable binocular disparity.

Accordingly, in projecting the camera coordinates to transform the camera coordinates into the clip coordinates, the terminal may perform a clipping technique to remove the objects that are not included in the space between the near plane 203 and the far plane, and may perform the clipping technique to remove the object A 205 that is included in the space 210 between the near plane 203 and the near plane 204, Thus, the terminal may render the object A 205 in such a manner that a user feels less eyestrain. Also, the terminal may render an object B 206 that is included in the space 211 between the near plane 204 and the far plane. For example, if the object A 205 included in the space 210 between the near plane 203 and the near plane 204 is rendered by combination of an alpha blending and a blur effect, it may be rendered while supplementing an excessive binocular disparity of a final binocular image.

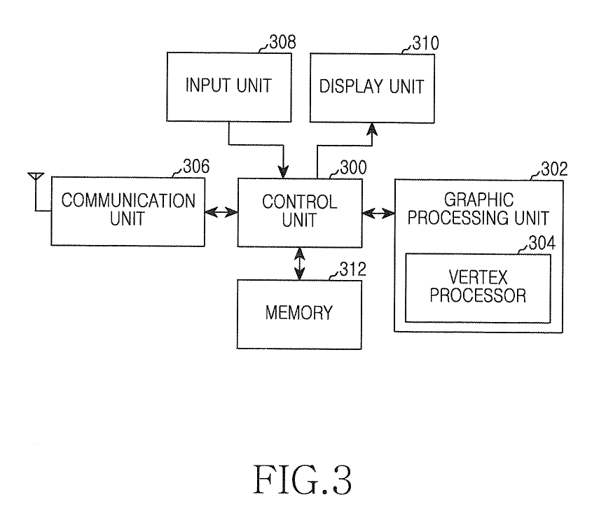

FIG. 3 illustrates an example configuration of a 3D graphic terminal according to an embodiment of the present invention.

The 3D graphic terminal according to this embodiment of the present invention includes a control unit 300, a graphic processing unit 302, a communication unit 306, an input unit 308, a display unit 310, and a memory 312. The graphic processing unit 302 includes a vertex processor 304.

The control unit 300 controls an overall operation of the terminal. In addition, the control unit 300 processes a function for rendering an object in the 3D graphic terminal.

The graphic processing unit 302 processes 3D graphic data. In addition to a general function, the graphic processing unit 302 includes a vertex processor 304 to perform a 3D graphic based object rendering. The vertex processor 304 performs a vertex processing of a 3D graphic pipeline. That is, the vertex processor 304 defines object coordinates, in which the center of an object is the center of a coordinate axis, based on vertex information (i.e., coordinates information) of each object existing in a space. The vertex processor 304 constructs world coordinates covering the entire space, based on the defined object coordinates. Then, the vertex processor 304 transforms the constructed world coordinates into camera coordinates that are centered on a virtual camera viewpoint, and determines objects to be rendered among the objects forming the entire space. The vertex processor 304 projects the camera coordinates and transforms the camera coordinates into clip coordinates to create a final binocular image. In addition to a general function, the vertex processor 304 analyzes a binocular disparity in a virtual space with respect to a target object in a vertex processing of a 3D graphic pipeline, and dynamically adjusts frustum parameters of a virtual camera. In addition, the vertex processor 304 clips an object whose binocular disparity in the virtual space is greater than an allowable binocular disparity, or renders the corresponding object in such a manner that a user may feel less eyestrain. Then, the vertex processor 304 provides a final binocular image having an allowable binocular disparity to the display unit 310 through the control unit 300. Accordingly, the display unit 310 outputs a binocular image and reproduces a 3D image.

The communication unit 306 includes a radio frequency (RF) transmitter for upconverting and amplifying a transmission (TX) signal, and a radio-frequency (RF) receiver for low-noise-amplifying and downconverting a received (RX) signal. In particular, the communication unit 306 may receive information necessary for execution of 3D contents (e.g., position information of objects, etc.) from an external network, and provide the received information to the graphic processing unit 302 and the memory 312 through the control unit 300.

The input unit 308 includes numeric keys and a plurality of function keys, such as a Menu key, a Cancel (Delete) key, a Confirmation key, and so on. The input unit 308 provides the control unit 300 with key input data that corresponds to a key pressed by a user. The key input values provided by the input unit 308 change a setting value (e.g., a position value) of the virtual camera.

The display unit 310 displays numerals and characters, moving pictures, still pictures and status information generated during the operation of the terminal. In particular, the display unit 310 displays the processed 3D graphic data. The display unit 310 may be a color liquid crystal display (LCD). Also, the display unit 310 has a physical feature that supports a stereoscopic multiview image output.

The memory 312 stores a variety of reference data and instructions of a program for the process and control of the control unit 300 and stores temporary data that are generated during the execution of various programs. In particular, the memory 312 stores a program for rendering an object in a 3D graphic terminal. In addition, the memory 312 stores information necessary for the execution of 3D contents (e.g., position information of objects, etc.) and frustum parameter values that are set in the creation of contents. The memory 312 provides the stored information and frustum parameter values to the graphic processing unit 302, upon execution of the contents. The graphic processing unit 302 performs a 3D graphic based object rendering using the received information and frustum parameter values. Furthermore, the memory 312 stores the allowable binocular disparity value.

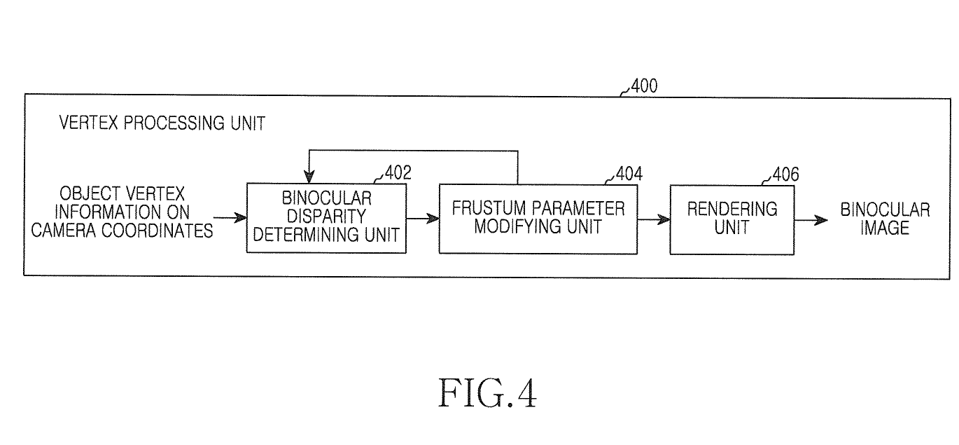

FIG. 4 illustrates an example detailed configuration of a vertex processor included in a graphic processing unit in a 3D graphic terminal according to an embodiment of the present invention.

The vertex processor 400 includes a binocular disparity determining unit 402, a frustum parameter modifying unit 404, and a rendering unit 406.

The binocular disparity determining unit 402 determines a binocular disparity in a virtual space with respect to a target object in a vertex processing of a 3D graphic pipeline. For example, the binocular disparity determining unit 402 maps an object on left and right screens by projecting a vertex of the object included in a space between a near plane and a far plane in a left frustum, which is defined centered on a left virtual camera viewpoint, and a right frustum, which is defined centered on a right camera viewpoint, based on object vertex information on camera coordinates, and determines a binocular disparity of the corresponding object by determining a difference of coordinates mapped on the left and right screens.

The frustum parameter modifying unit 404 dynamically adjusts frustum parameters (especially, a near plane) of a virtual camera, based on the determined binocular disparity. That is, if the determined binocular disparity is greater than the allowable binocular disparity, the frustum parameter modifying unit 404 transforms the near plane into a near plane to which the allowable binocular disparity is reflected. In other words, the position of the near plane on the Z-axis is changed such that a binocular disparity of an object to be included in a final binocular image becomes less than or equal to the allowable binocular disparity. To this end, the frustum parameter modifying unit 404 changes the position of the near plane on the Z-axis by a predetermined distance and provides the changed near plane to the binocular disparity determining unit 402. These procedures are repeated until the binocular disparity of the object to be included in the final binocular image becomes less than or equal to the allowable binocular disparity. Then, if it is determined that the binocular disparity of the object to be included in the final binocular image is less than or equal to the allowable binocular disparity, the frustum parameter modifying unit 404 outputs a frustum to which the finally adjusted frustum parameters are applied.

The rendering unit 406 clips an object whose binocular disparity in the virtual space is greater than the allowable binocular disparity, or renders the corresponding object in such a manner that a user may feel less eyestrain. That is, an object included in a space between a near plane before adjustment and a near plane after final adjustment in the frustum is removed by clipping, or it is rendered by a rendering scheme (e.g., an alpha blending and a blur effect) in such a manner that a user feels less eyestrain. In addition, the rendering unit 406 performs a rendering on an object included in a space between a near plane after final adjustment and a far plane in the frustum, and performs a clipping to remove an object that is not included in a space between a near plane before adjustment and a far plane. Therefore, the rendering unit 406 may output a final binocular image having the allowable binocular disparity.

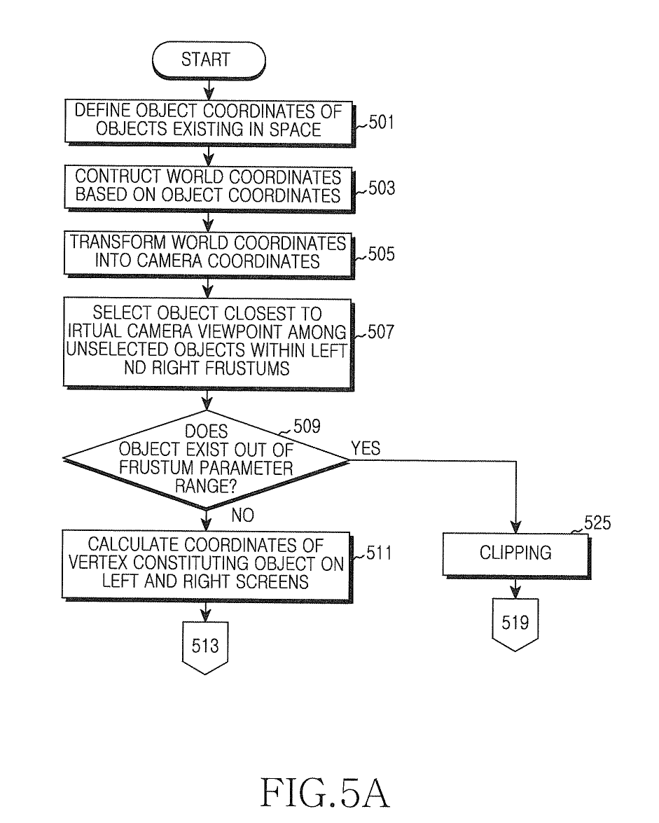

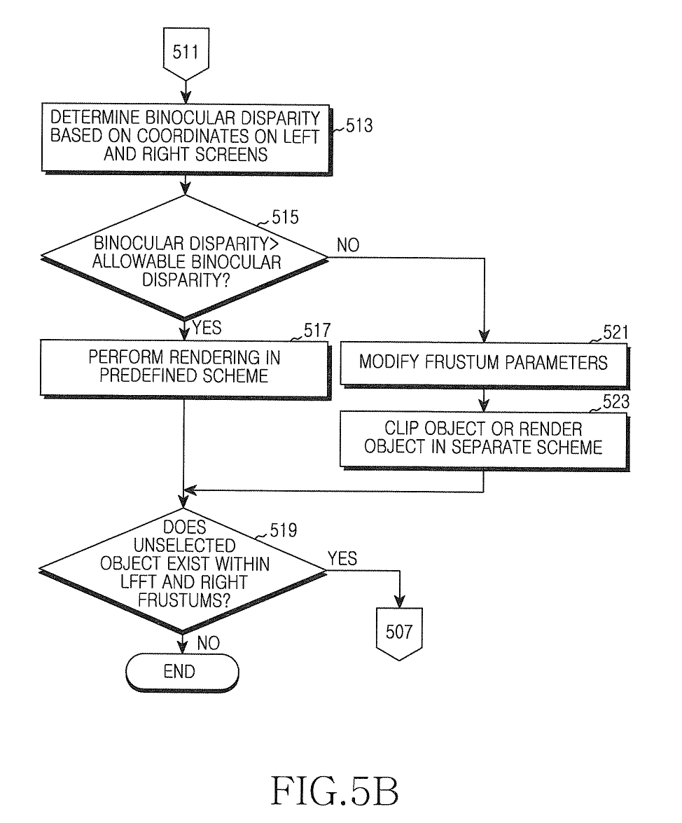

FIG. 5 illustrates an example method for rendering an object in a 3D graphic terminal according to an embodiment of the present invention.

In block 501, the terminal defines object coordinates, in which the center of an object is the center of a coordinate axis, based vertex information (i.e., coordinate information) of objects existing in a space.

In block 503, the terminal constructs world coordinates covering an entire space, based on the defined object coordinates.

In block 505, the terminal transforms the constructed world coordinates into camera coordinates centered on the virtual camera viewpoint.

In block 507, the terminal selects an object closest to the virtual camera viewpoint among unselected objects within the left frustum, which is defined centered on the left virtual camera viewpoint, and the right frustum, which is defined centered on the right virtual camera viewpoint, based on the object vertex information on the transformed camera coordinates.

In block 509, the terminal determines whether the selected object exists out of the frustum parameter range. That is, the terminal determines whether the selected object is not included in the space between the near plane and the far plane.

If it is determined in block 509 that the selected object does not exist out of the frustum parameter range, the terminal projects a vertex constituting the selected object and calculates coordinates mapped on the left and right screens in block 511.

In block 513, the terminal calculates a difference of coordinates, based on the calculated coordinates mapped on the left and right screens, and determines the binocular disparity of the corresponding object. That is, the terminal determines a binocular disparity of the corresponding object by using a difference of the calculated coordinates on the left and right screens.

In block 515, the terminal determines whether the determined binocular disparity is greater than the allowable binocular disparity.

If it is determined in block 515 that the determined binocular disparity is not greater than the allowable binocular disparity, the terminal determines the selected object as an object from which a user can feel a 3D effect. Then, the terminal renders the selected object in accordance with a scheme predefined by a developer in block 517, without modifying the frustum parameters, and proceeds to block 519.

Alternatively, if it is determined in block 515 that the determined binocular disparity is greater than the allowable binocular disparity, the terminal determines the selected object as an object from which a user cannot feel a 3D effect. In block 521, the terminal modifies the frustum parameters, that is, transforms a near plane into a near plane to which the allowable binocular disparity is reflected. In block 523, the terminal clips the selected object or renders the selected object by a separate rendering scheme (e.g., alpha blending and a blur effect) that relieves eyestrain, and proceeds to block 519.

If it is determined in block 509 that the selected object exists out of the frustum parameter range, the terminal clips the selected object in block 525 and proceeds to block 519.

In block 519, the terminal determines whether unselected objects exist within the left frustum and the right frustum.

If it is determined in block 519 that the unselected objects exist within the left frustum and the right frustum, the terminal determines that all objects to be displayed in a single scene are not rendered, and returns to block 507 to repeat the subsequent processes.

On the other hand, if it is determined in block 519 that the unselected objects do not exist within the left frustum and the right frustum, the terminal determines that all objects to be displayed in a single scene are rendered and thus a single scene is completed. Then, the terminal ends the algorithm according to the embodiment of the present invention. Accordingly, the terminal may output the final binocular image having the allowable binocular disparity.

It has been described on the assumption that an object is set in a basic rendering unit, a polygon constructed with three vertexes may be set as a basic unit.

As described above, the 3D graphic terminal dynamically adjusts frustum parameters of a virtual camera by analyzing a binocular disparity in a virtual space with respect to a target object in a vertex processing of a 3D graphic pipeline, and clips an object, whose binocular disparity is greater than an allowable binocular disparity in a virtual space, or renders the corresponding object by a rendering scheme that reduces the occurrence of diplopia effect and thereby relieves a user's eyestrain.

While the invention has been shown and described with reference to certain preferred embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A method for rendering an object in a three-dimensional (3D) graphic terminal, comprising:
determining camera coordinates, based on vertex information of objects existing in a 3D space;
selecting one object in a left frustum and a right frustum, based on the constructed camera coordinates, wherein the left frustum is defined centered on a left virtual camera viewpoint, and the right frustum is defined centered on a right virtual camera viewpoint;
determining a binocular disparity by projecting vertexes of the selected object in the left frustum and the right frustum; and
adjusting frustum parameters of the left virtual camera and the right virtual camera when the determined binocular disparity is greater than an allowable binocular disparity.

2. The method of claim 1, wherein the selecting of the object comprises:
selecting an object closest to the viewpoint of the left virtual camera and the right virtual camera among unselected objects within the left frustum and the right frustum.

3. The method of claim 1, further comprising:
determining whether the selected object exists out of a frustum parameter range; and
clipping the selected object when it is determined that the selected object exists out of the frustum parameter range;
wherein the determining of the binocular disparity is performed when it is determined that the selected object does not exist out of the frustum parameter range.

4. The method of claim 1, wherein the determining of the binocular disparity comprises:
calculating coordinates mapped on a left screen and a right screen by projecting the vertexes of the selected object in the left frustum and the right frustum; and
determining the binocular disparity by using a difference between coordinates on the left screen and coordinates on the right screen.

5. The method of claim 1, wherein the adjusting of the frustum parameters comprises changing the frustum parameters to frustum parameters to which an allowable binocular disparity is reflected.

6. The method of claim 1, further comprising clipping the selected object or rendering the selected object in a separate rendering scheme different from a predefined rendering scheme.

7. The method of claim 6, wherein the separate rendering scheme is at least one of an alpha blending and a blur effect.

8. The method of claim 1, further comprising:
rendering the selected object in a predefined scheme, without modifying the frustum parameters, when it is determined that the determined binocular disparity is not greater than the allowable binocular disparity.

9. A 3D graphic terminal, comprising:
a binocular disparity determining unit operable to:
construct camera coordinates, based on vertex information of objects existing in a 3D space;
select one object in a left frustum and a right frustum, based on the constructed camera coordinates, wherein the left frustum is defined centered on a left virtual camera viewpoint and the right frustum is defined centered on a right virtual camera viewpoint; and
determine a binocular disparity by projecting vertexes of the selected object in the left frustum and the right frustum; and
a frustum parameter modifying unit operable to adjust frustum parameters of the left virtual camera and the right virtual camera when the determined binocular disparity is greater than an allowable binocular disparity.

10. The 3D graphic terminal of claim 9, wherein the binocular disparity determining unit is operable to:
select an object closest to the viewpoint of the left virtual camera and the right virtual camera among unselected objects within the left frustum and the right frustum.

11. The 3D graphic terminal of claim 9, wherein the binocular disparity determining unit is operable to:
determine whether the selected object exists out of a frustum parameter range, controls a rendering unit to clip the selected object when it is determined that the selected object exists out of the frustum parameter range; and
determine the binocular disparity when it is determined that the selected object does not exist out of the frustum parameter range.

12. The 3D graphic terminal of claim 9, wherein the binocular disparity determining unit is operable to calculate coordinates mapped on a left screen and a right screen by projecting the vertexes of the selected object in the left frustum and the right frustum; and
determine the binocular disparity by using a difference between coordinates on the left screen and coordinates on the right screen.

13. The 3D graphic terminal of claim 9, wherein the frustum parameter modifying unit changes the frustum parameters to frustum parameters to which an allowable binocular disparity is reflected.

14. The 3D graphic terminal of claim 9, further comprising a rendering unit operable to:
clip the selected object or rendering the selected object in a separate rendering scheme different from a predefined rendering scheme.

15. The 3D graphic terminal of claim 14, wherein the separate rendering scheme is at least one of an alpha blending and a blur effect.

16. The 3D graphic terminal of claim 9, further comprising a rendering unit operable to:
render the selected object in a predefined scheme, without modifying the frustum parameters, when it is determined that the determined binocular disparity is not greater than the allowable binocular disparity.

17. A 3D graphic terminal, comprising:
a graphic processing unit for processing 3D graphic data, wherein the graphic processing unit comprises:
a binocular disparity determining unit operable to
construct camera coordinates, based on vertex information of objects existing in a 3D space;
select one object in a left frustum and a right frustum, based on the constructed camera coordinates, wherein the left frustum is defined centered on a left virtual camera viewpoint and the right frustum is defined centered on a right virtual camera viewpoint; and
determine a binocular disparity by projecting vertexes of the selected object in the left frustum and the right frustum; and
a frustum parameter modifying unit operable to adjust frustum parameters of the left virtual camera and the right virtual camera when the determined binocular disparity is greater than an allowable binocular disparity; and
a display unit operable to display the processed 3D graphic data.

18. The 3D graphic terminal of claim 17, wherein the binocular disparity determining unit is operable to:
select an object closest to the viewpoint of the left virtual camera and the right virtual camera among unselected objects within the left frustum and the right frustum.

19. The 3D graphic terminal of claim 17, wherein the binocular disparity determining unit is operable to:
determine whether the selected object exists out of a frustum parameter range;
control a rendering unit to clip the selected object when it is determined that the selected object exists out of the frustum parameter range; and
determine the binocular disparity when it is determined that the selected object does not exist out of the frustum parameter range.

20. The 3D graphic terminal of claim 17, wherein the binocular disparity determining unit is operable to:
determine coordinates mapped on a left screen and a right screen by projecting the vertexes of the selected object in the left frustum and the right frustum; and
determine the binocular disparity by using a difference between coordinates on the left screen and coordinates on the right screen.
